(19) United States
(12) Patent Application Publication
(10) Pub. No.: US 2024/0229267 A9
(43) Pub. Date: Jul. 11, 2024

(54) ELECTROLYZER SYSTEM WITH VAPORIZER COOLING SYSTEM

(71) Applicant: FuelCell Energy, Inc., Danbury, CT (US)

(72) Inventor: Jonathan MALWITZ, Danbury, CT (US)

(21) Appl. No.: 18/490,010

(22) Filed: Oct. 19, 2023

Related U.S. Application Data
(60) Provisional application No. 63/418,101, filed on Oct. 21, 2022.

(51) Int. Cl. C25B 15/021; C25B 1/042; C25B 9/67; C25B 15/023; C25B 15/08

(52) U.S. Cl. CPC C25B 15/021; C25B 1/042; C25B 9/67; C25B 15/023; C25B 15/087

(57) ABSTRACT

An electrolyzer system includes a vaporizer configured to store a first volume of liquid water and to vaporize water to humidify a cathode inlet stream of an electrolyzer cell module, a cold water tank positioned at a height greater than that of the first volume of liquid water and configured to store a second volume of water, and a valve configured to open and close. The water from the cold water tank is allowed to flow through the valve into the vaporizer when the valve is open.

### CROSS-REFERENCE TO RELATED PATENT APPLICATION

This application claims the benefit of and priority to U.S. Provisional Application No. 63/418,101, filed on Oct. 21, 2022, which is incorporated by reference herein in its entirety.

### BACKGROUND

The present disclosure relates generally to the field of electrochemical cells, such as fuel cells and electrolyzer cells, and more particularly to electrolyzer cell systems with exhaust recycle systems.

Generally, a fuel cell includes an anode, a cathode, and an electrolyte layer that together drive chemical reactions to produce electricity. Multiple fuel cells may be arranged in a stack to produce a desired amount of electricity. Fuel, such as hydrogen gas or hydrocarbon gas, is supplied to the anode while oxidant is supplied to the cathode. The fuel and oxidant are used up by the electrochemical reactions as they flow over the anode and cathode, respectively.

A fuel cell may be operated in reverse as an electrolyzer cell in which the anode acts as a cathode and the cathode acts as the anode. In electrolyzer mode, an external power source provides an electric current to the cell. Steam is supplied to the cathode (the fuel cell anode) and air is supplied to the anode (the fuel cell cathode). Oxygen ions from the steam cross over to the anode, while the hydrogen remains in the cathode. The air supplied to the anode dilutes the oxygen and sweeps it out of the electrolyzer cell. The cathode outputs a mixture of hydrogen gas and unreacted steam that is recycled to the cathode after being further humidified in a vaporizer 102.

### SUMMARY

Systems and methods of the current disclosure relate to an electrolyzer system that includes a cold water storage tank that can provide cold water to a vaporizer tank to rapidly cool the water in the vaporizer tank in the event of a system malfunction.

One embodiment relates to an electrolyzer system, which includes a vaporizer configured to store a first volume of liquid water and to vaporize water to humidify a cathode inlet stream of an electrolyzer cell module, a cold water tank positioned at a height greater than that of the first volume of liquid water and configured to store a second volume of water, and a valve configured to open and close. The water from the cold water tank is allowed to flow through the valve into the vaporizer when the valve is open.

In one aspect, which is combinable with any other aspects or embodiments, the electrolyzer system further includes a controller configured to reduce the pressure in the vaporizer and to open the valve in response to receiving an indication of a malfunction in the electrolyzer system.

In one aspect of the electrolyzer system, which is combinable with any other aspects or embodiments, the indication of a malfunction includes one or more of: a sudden change in temperature in the electrolyzer cell module, a sudden change in voltage in the electrolyzer cell module, a sudden change in current generated in the electrolyzer cell module, a sudden change in gas flow rate or pressure to the electrolyzer cell module, or a malfunction in an anode air blower.

In one aspect, which is combinable with any other aspects or embodiments, the electrolyzer system further includes a pressure release valve configured to open to reduce the pressure in the vaporizer in response to a command from the controller.

In one aspect of the electrolyzer system, which is combinable with any other aspects or embodiments, the valve is a fail open valve that requires an electrical signal to remain closed.

In one aspect of the electrolyzer system, which is combinable with any other aspects or embodiments, the valve is configured to open upon occurrence of a power failure in the electrolyzer system.

In one aspect of the electrolyzer system, which is combinable with any other aspects or embodiments, the vaporizer is configured to receive a recycle stream from the electrolyzer cell module and to humidify the recycle stream to form the cathode inlet stream.

In one aspect of the electrolyzer system, which is combinable with any other aspects or embodiments, the cold water tank includes a cold water inlet configured to receive additional water, and the electrolyzer system further includes a pipe with a first end fluidly coupled to the cold water tank at a first height above the bottom of the cold water tank and a second end fluidly coupled to the vaporizer at a position above a water level of the first volume of liquid water.

In one aspect of the electrolyzer system, which is combinable with any other aspects or embodiments, the pipe is configured such that water from the second volume of water flows into the vaporizer via the pipe when the second volume of water exceeds the first height.

In one aspect of the electrolyzer system, which is combinable with any other aspects or embodiments, the pipe is configured to allow gas to flow from the vaporizer into the cold water tank when the second volume of water flows into the vaporizer.

Another embodiment relates to a method of cooling a vaporizer in an electrolyzer system, the vaporizer containing a volume of hot liquid water. The method includes providing a cold water tank containing a volume of cold water positioned at a height greater than that of the volume of hot liquid water, detecting a malfunction in the electrolyzer system, reducing, in response to detecting the malfunction, a gas pressure in the vaporizer, and releasing, in response to detecting the malfunction, the volume of cold water into the vaporizer.

In one aspect of the method, which is combinable with any other aspects or embodiments, releasing the volume of cold water into the vaporizer includes opening a valve positioned between the cold water tank and the vaporizer.

In one aspect of the method, which is combinable with any other aspects or embodiments, the valve is a fail open valve that requires an electrical signal to remain closed.

In one aspect of the method, which is combinable with any other aspects or embodiments, the valve is configured to open upon occurrence of a power failure in the electrolyzer system.

In one aspect of the method, which is combinable with any other aspects or embodiments, the cold water tank and the vaporizer are arranged such that the cold water flows into the vaporizer under the force of gravity.

In one aspect of the method, which is combinable with any other aspects or embodiments, reducing the gas pressure in the vaporizer includes opening a pressure release valve.

In one aspect of the method, which is combinable with any other aspects or embodiments, reducing the gas pressure includes reducing the gas pressure from a pressure above ambient pressure to ambient pressure.

In one aspect of the method, which is combinable with any other aspects or embodiments, the malfunction includes one or more of: a sudden change in temperature in an electrolyzer cell module of the electrolyzer system, a sudden change in voltage in the electrolyzer cell module, a sudden change in current generated in the electrolyzer cell module, a sudden change in gas flow rate or pressure to the electrolyzer cell module, or a malfunction in an anode air blower.

In one aspect of the method, which is combinable with any other aspects or embodiments, the cold water is released into the vaporizer at a position below the top of the volume of hot liquid water.

In one aspect of the method, which is combinable with any other aspects or embodiments, the volume of cold water has a volume and a temperature such that, when the volume of cold water flows into the vaporizer, the temperature of a volume of hot liquid water in the vaporizer drops from above 100 degrees Celsius to below 100 degrees Celsius.

In one aspect, which is combinable with any other aspects or embodiments, the method further includes supplying additional cold water to the cold water tank. Cold water is allowed to flow into the vaporizer when the volume of cold water exceeds a first height in the cold water tank.

In one aspect of the method, which is combinable with any other aspects or embodiments, the volume of cold water has a volume below the first height and a temperature such that, when the volume of cold water flows into the vaporizer, the temperature of a volume of hot liquid water in the vaporizer drops from above 100 degrees Celsius to below 100 degrees Celsius.

In one aspect of the method, which is combinable with any other aspects or embodiments, the cold water tank includes a pipe coupled to the vaporizer, the pipe positioned at the first height and configured to allow cold water to flow into the vaporizer when the volume of cold water exceeds the first height.

In one aspect of the method, which is combinable with any other aspects or embodiments, the pipe is configured to allow gas to flow from the vaporizer to the cold water tank when the volume of cold water flows into the vaporizer.

In one aspect, which is combinable with any other aspects or embodiments, the method further includes supplying an electrolyzer cell recycle stream to the vaporizer and vaporizing water in the vaporizer to humidify the electrolyzer cell recycle stream.

### BRIEF DESCRIPTION OF THE DRAWINGS

FIG. 1 is a schematic diagram of an electrolyzer system, according to an exemplary embodiment.

FIG. 2 is a flow diagram of a method of cooling a vaporizer in an electrolyzer system, according to an exemplary embodiment.

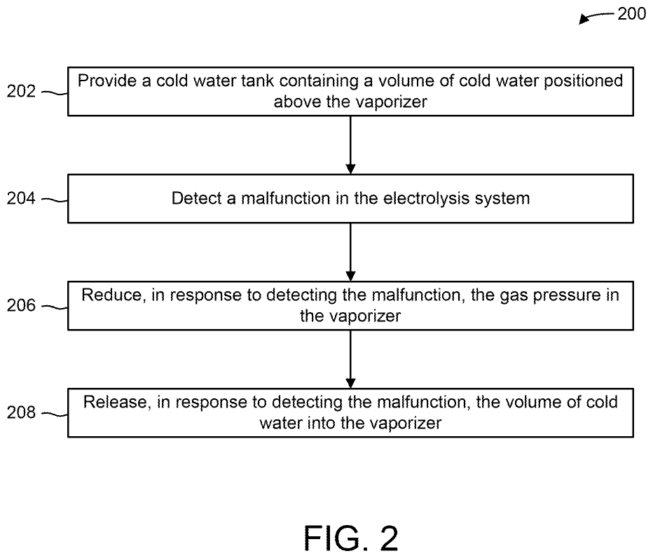

It will be recognized that the Figures are schematic representations for purposes of illustration. The Figures are provided for the purpose of illustrating one or more implementations with the explicit understanding that the Figures will not be used to limit the scope of the meaning of the claims.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Electrolyzer cell systems may be operated at elevated pressures to improve efficiency. Large pressure differentials between the anodes and cathodes can result in damage to the cells and other components in the system. In the event of a sudden loss of power to an electrolyzer cell system (e.g., upon the occurrence of a system failure, power outage, etc.), the system may be configured to reduce the pressure to both the anodes and the cathodes of the electrolyzer cells to reduce the pressure differential and prevent damage. For example, both the anodes and cathodes of the electrolyzer cells may be vented to atmospheric pressure (e.g., ambient pressure) upon the occurrence of a power failure.

An electrolyzer cell cathode recycle stream comprising hydrogen and steam may be further humidified in a vaporizer (e.g., a bubbler humidifier), which may include a pressurized tank of water heated to temperatures above 100 degrees Celsius. Because the water is heated to above 100 degrees Celsius, reducing the cathode pressure to protect the electrolyzer cells can cause rapid boiling and vaporization of the water in the tank, which can result in the water boiling out of the tank. This may damage electrolyzer system equipment.

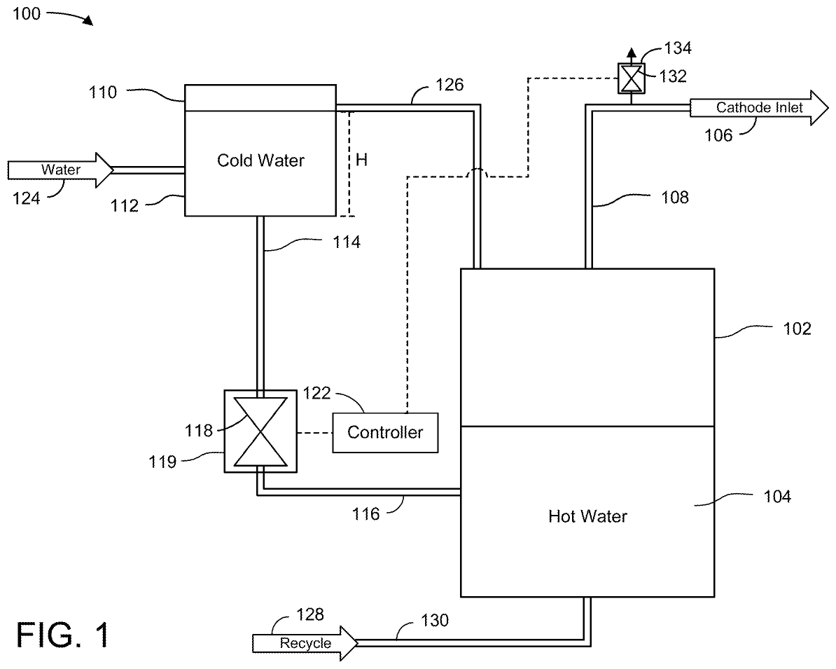

Referring now to FIG. 1, an electrolyzer system 100 is shown, according to an exemplary embodiment. The vaporizer 102 includes a water tank and a heat source and is configured to boil hot water 104 (e.g., a first volume of water) to humidify a cathode inlet stream 106. The cathode inlet stream 106 is directed to a cathode of an electrolyzer cell (e.g., a solid oxide electrolyzer cell) or to cathodes of multiple electrolyzer cells arranged in one or more stacks in an electrolyzer cell module. During operation of the electrolyzer system 100, the hot water 104 in the vaporizer 102 is maintained at an elevated temperature and pressure. For example, the hot water 104 may be maintained at a temperature above 100 degrees Celsius and a pressure above 1 atm. A recycle stream 128 from the electrolyzer containing hydrogen gas and steam is input via pipe 130 into the bottom of the vaporizer 102. The hot water 104, which may be stored in the vaporizer 102 as a liquid, is boiled in the vaporizer 102, and the steam generated, as well as the hydrogen gas and steam from the recycle stream 128, travels to the cathode of the electrolyzer via a pipe 108 as a cathode inlet stream 106. In the event of rapid depressurization in the vaporizer 102, for example, due to a sudden shutdown of the electrolyzer system 100 due to a power failure, the hot water 104 may rapidly boil as the boiling point of water drops with the pressure in the vaporizer 102.

The electrolyzer system 100 includes a cold water tank 110 containing cold water 112 (e.g., a second volume of water) positioned at a height greater than that of the vaporizer 102. The cold water 112 is below 100 degrees Celsius. For example, the cold water 112 may be approximately 25 degrees Celsius, or between 15 degrees Celsius and 35 degrees Celsius. In the event of sudden depressurization of the vaporizer 102, the cold water 112 may flow into to the vaporizer 102 to rapidly cool the hot water 104. The cold water 112 may travel through pipes 114 and 116 to the vaporizer 102 under the force of gravity. The cold water tank 110 may be positioned at any location that allows the cold water 112 to flow into the vaporizer 102 under the force of gravity. The volume and temperature of the cold water 112 are such that when the cold water 112 flows into the vaporizer 102 102, the temperature of the hot water 104 falls from a temperature above 100 degrees Celsius to a temperature below 100 degrees Celsius, thus stopping the boiling and vaporization of the hot water 104. In some embodiments, pipe 116 may be fluidly coupled to the vaporizer 102 at a position below the water level of the hot water 104 to allow a controlled flow of water into the vaporizer 102. The amount of water that remains in the pipes 114, 116 after the cold water 112 flows into the vaporizer 102 can be taken into account when determining the volume of cold water 112 required. In some embodiments, pipe 116 may be coupled to the vaporizer 102 at a position high enough that all of the cold water 112 can flow out of the pipes 114, 116.

During normal operation of the electrolyzer system 100, a valve 118 (e.g., a valve of a valve assembly) remains closed, preventing the cold water 112 from traveling from pipe 114 to pipe 116 and into the vaporizer 102. Upon the occurrence of a power outage (e.g., a power failure), the cathode side and anode side of the electrolyzer cells may be allowed to drop to atmospheric pressure to protect the cells from large pressure differentials. When the pressure on the cathode side drops, the hot water 104 in the vaporizer 102, which is above 100 degrees Celsius, may rapidly boil unless it is cooled. The valve 118 is configured to open upon the occurrence of a power failure so that the cold water 112 can cool the hot water 104. For example, the valve 118 may be a “fail open” valve that requires an electrical signal to remain closed. When there is a power outage in the electrolyzer system 100, and no electrical signal can reach the valve 118, the valve 118 will open. As noted above, the cold water tank 110 is positioned at a height greater than that of the vaporizer 102. When the valve 118 opens, cold water 112 flows through pipe 114, valve 118, and pipe 116 under the force of gravity into the vaporizer 102. The cold water 112 mixes with the hot water 104 in the vaporizer 102 to rapidly cool the hot water 104 to a temperature below 100 degrees Celsius, thus stopping the hot water 104 from boiling at atmospheric pressure.

In some embodiments, other events may trigger the opening of the valve 118. For example, the electrolyzer system 100 may include a controller 122 configured to control the pressure in the electrolyzer cells and to open and close the valve 118. The controller 122 may receive information from various sensors indicating a malfunction that requires a shutdown of the electrolyzer cell system 100 and a drop in pressure to both the anode side and cathode side of the electrolyzer cells. For example, a sudden change in temperature in the electrolyzer cells, a sudden change in voltage or current consumed by the electrolyzer cells, or a sudden change in gas flow to the electrolyzer cells could indicate that there is a malfunction in the system 100. It should be understood that “sudden,” as used above, may refer to any changes that occur more rapidly than would be expected under normal operating conditions of the electrolyzer system 100. The controller 122 can be configured to open valves to drop the pressure to the anode side and the cathode side of the electrolyzer cells and to open the valve 118. For example, the controller 122 may open the valve 118 in response to receiving an indication of a malfunction in the anode air blower, which causes the anode pressure to drop. These examples are not intended to be limiting. The controller 122, in response to various indications of a malfunction in the system 100, may be configured to rapidly reduce the pressure in both sides of the electrolyzer cells and to open the valve 118 to allow the cold water 112 to flow into the vaporizer 102.

Cold water is fed into a cold water inlet of the cold water tank 110 via a fresh water inlet stream 124. The water from fresh water inlet stream 124 may be deionized water at approximately 25 degrees Celsius or between 15 degrees Celsius and 35 degrees Celsius. When the cold water 112 in the cold water tank 110 reaches a height H, cold water can flow into the vaporizer 102 via pipe 126. During normal system operation, water may be fed into the cold water tank 110 and may flow into the vaporizer 102 at a substantially equal rate to the rate at which vaporized water exits the vaporizer 102 via pipe 108. Thus, the water level in the vaporizer 102 may remain substantially constant as vaporized water is replaced by water from the cold water tank 110 via pipe 126. The height H at which pipe 126 is coupled to the cold water tank 110 is determined based on the volume of cold water 112 in the cold water tank 110 required to rapidly cool the vaporizer 102 in the event of sudden depressurization. For example, if it is determined that two cubic meters of water is required to cool the hot water 104 in the vaporizer 102 to below 100 degrees Celsius, and the cold water tank 110 is rectangular with a width of one meter and a length of one meter, the height H may be two meters. By coupling pipe 126 to the cold water tank 110 at height H, the vapor space pressures of both the vaporizer 102 and the cold water tank 110 may be balanced, allowing unimpeded flow of cold water to the vaporizer through the pipes 114, 116 when valve 118 is opened. Pipe 126 may also maintain a constant volume of water in the cold water tank 110, as any water in the cold water tank 110 above height H may flow through pipe 126 to the vaporizer 102.

Further, because the pipe 126 is coupled to the top of the vaporizer 102 and the top of the cold water tank 110 vaporized water and other gases from the vaporizer 102 can travel through the pipe 126 to the cold water tank 110. When the valve 118 opens to rapidly cool the vaporizer 102, gas from the vaporizer 102 can flow through the pipe 126 to replace the volume of the cold water tank 110 as the cold water 112 flows out. Thus, the pipe 126 acts as a vacuum break to allow the cold water 112 to flow freely into the vaporizer 102.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. An electrolyzer system comprising:
a vaporizer configured to store a first volume of liquid water and to vaporize water to humidify a cathode inlet stream of an electrolyzer cell module;
a cold water tank positioned at a height greater than that of the first volume of liquid water and configured to store a second volume of water; and
a valve configured to open and close, wherein the water from the cold water tank is allowed to flow through the valve and into the vaporizer when the valve is open.

2. The electrolyzer system of claim 1, further comprising a controller configured to reduce the pressure in the vaporizer and to open the valve in response to receiving an indication of a malfunction in the electrolyzer system.

3. The electrolyzer system of claim 2, wherein the indication of the malfunction comprises one or more of: a sudden change in temperature in the electrolyzer cell module, a sudden change in voltage in the electrolyzer cell module, a sudden change in current generated in the electrolyzer cell module, a sudden change in gas flow rate or pressure to the electrolyzer cell module, or a detected malfunction in an anode air blower.

4. The electrolyzer system of claim 2, further comprising a pressure release valve configured to open to reduce the pressure in the vaporizer in response to a command from the controller.

5. The electrolyzer system of claim 1, wherein the valve is a fail open valve that requires an electrical signal to remain closed.

6. The electrolyzer system of claim 1, wherein the vaporizer is configured to receive a recycle stream from the electrolyzer cell module and to humidify the recycle stream to form the cathode inlet stream.

7. The electrolyzer system of claim 1, wherein:
the cold water tank comprises a cold water inlet configured to receive additional water; and
the electrolyzer system further comprises a pipe with a first end fluidly coupled to the cold water tank at a first height above the bottom of the cold water tank and a second end fluidly coupled to the vaporizer at a position above a water level of the first volume of liquid water.

8. The electrolyzer system of claim 7, wherein the pipe is configured to allow water from the second volume of water to flow into the vaporizer via the pipe when the second volume of water exceeds the first height.

9. The electrolyzer system of claim 7, wherein the pipe is configured to allow gas to flow from the vaporizer into the cold water tank when the second volume of water flows into the vaporizer.

10. A method of cooling a vaporizer in an electrolyzer system, the vaporizer containing a volume of hot liquid water, the method comprising:
detecting a malfunction in the electrolyzer system, and, in response to detecting such malfunction:
reducing a gas pressure in the vaporizer; and
releasing a volume of cold water into the vaporizer from a cold water tank that is positioned at a height greater than that of the volume of hot liquid water.

11. The method of claim 10, wherein releasing the volume of cold water into the vaporizer comprises opening a valve positioned between the cold water tank and the vaporizer.

12. The method of claim 10, wherein the cold water tank and the vaporizer are arranged such that the cold water flows into the vaporizer under the force of gravity.

13. The method of claim 10, wherein reducing the gas pressure in the vaporizer comprises opening a pressure release valve.

14. The method of claim 13, wherein reducing the gas pressure in the vaporizer comprises reducing the gas pressure from a pressure above ambient pressure to ambient pressure.

15. The method of claim 10, wherein the malfunction comprises one or more of: a sudden change in temperature in an electrolyzer cell module of the electrolyzer system, a sudden change in voltage in the electrolyzer cell module, a sudden change in current generated in the electrolyzer cell module, a sudden change in gas flow rate or pressure to the electrolyzer cell module, or a malfunction in an anode air blower.

16. The method of claim 10, wherein the cold water is released into the vaporizer at a position below the top of the volume of hot liquid water.

17. The method of claim 10, wherein the volume of cold water has a volume and a temperature such that, when the volume of cold water flows into the vaporizer, the temperature of a volume of hot liquid water in the vaporizer drops from 100 degrees Celsius or higher to below 100 degrees Celsius.

18. The method of claim 10, further comprising supplying additional cold water to the cold water tank, wherein cold water is allowed to flow into the vaporizer when the volume of cold water exceeds a first height in the cold water tank.

19. The method of claim 18, wherein the volume of cold water has a volume below the first height and a temperature such that, when the volume of cold water flows into the vaporizer, the temperature of a volume of hot liquid water in the vaporizer drops from 100 degrees Celsius or higher to below 100 degrees Celsius.

20. The method of claim 10, further comprising:
supplying an electrolyzer cell recycle stream to the vaporizer; and
vaporizing water in the vaporizer to humidify the electrolyzer cell recycle stream.
